(19) United States
(12) Patent Application Publication
(10) Pub. No.: US 2006/0226976 A1
(43) Pub. Date: Oct. 12, 2006

(54) Device for helping find a remote control

(76) Inventors: Hsu-Jung Wei, Fongshan City (TW); Su-Jung Yang, Kaohsiung City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/091,494

(22) Filed: Mar. 29, 2005

(51) Int. Cl. G08B 1/08

(52) U.S. Cl. 340/539.32; 340/825.69

(57) ABSTRACT

A device includes a receiving mechanism, a transmitting mechanism, and a signaling mechanism; the receiving mechanism is positioned in a remote control of an electrical equipment; the signaling mechanism is electrically connected to the receiving mechanism; the transmitting mechanism can be positioned in the electrical equipment; alternatively, the transmitting mechanism can be positioned outside the electrical equipment; the signaling mechanism will produce signals such as light and sound when the receiving mechanism receives signals transmitted from the transmitting mechanism, thus helping the user find the remote control.

### BACKGROUND OF THE INVENTION

1. Field of the Invention

The present invention relates to a device for helping find a remote control of an electrical equipment, more particularly one, which can produce signals to help one person find the remote control if he/she doesn't know or has forgotten the place where the remote control was put.

2. Brief Description of the Prior Art

Electrical and electronic equipments, e.g. televisions, air conditioners, electric fans, stereos, and videos, will be more convenient to use if they are equipped with remote controls.

However, because such remote controls are not very big in size, and because people can put the remote controls at any place after using them, the next person who wants to use the remote controls may have to spend much time searching for the remote controls.

### SUMMARY OF THE INVENTION

It is a main object of the invention to provide a device for helping find a remote control to overcome the above-mentioned problem.

The device of the present invention includes a receiving mechanism, a transmitting mechanism, and a signaling mechanism. The receiving mechanism is positioned in a remote control of an electrical equipment. The signaling mechanism is connected to the receiving mechanism. The transmitting mechanism can be positioned in the electrical equipment, or alternatively it can be positioned outside the electrical equipment. The signaling mechanism will produce signals when the receiving mechanism receives signals transmitted from the transmitting mechanism, thus helping the user find the remote control.

### BRIEF DESCRIPTION OF THE DRAWINGS

The present invention will be better understood by referring to the accompanying drawings, wherein:

FIG. 1 is a block diagram of the first preferred embodiment in the present invention,

FIG. 2 is a block diagram of the second preferred embodiment, and

FIG. 3 is a flow chart showing the way to use the device of the present invention.

### DETAILED DESCRIPTION OF THE PREFERRED EMBODIMENTS

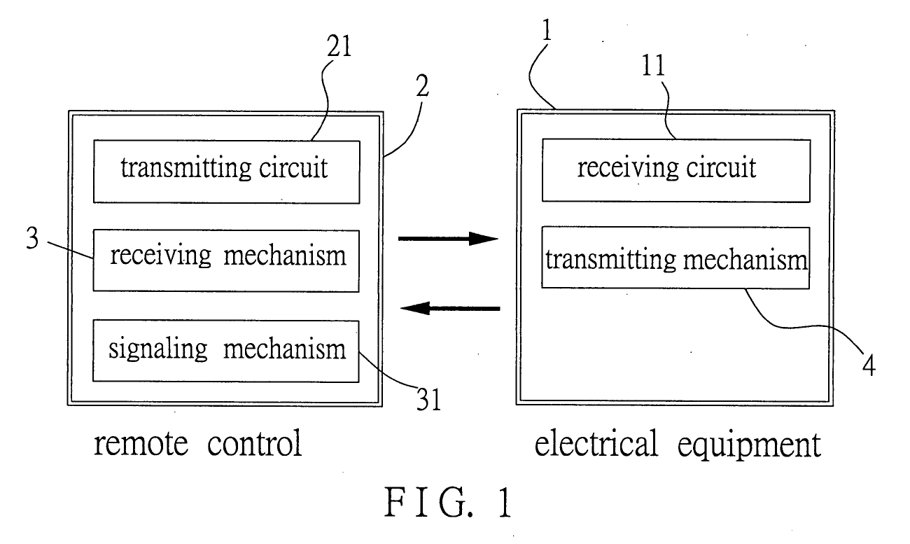

Referring to FIG. 1, a first preferred embodiment of a device for helping find a remote control includes a transmitting mechanism 4, a receiving mechanism 3, and a signaling mechanism 31.

The transmitting mechanism 4 is positioned in an electrical (electronic) equipment 1, which equipment 1 has a receiving circuit 11 therein as well.

The receiving mechanism 3 is positioned in a remote control 2 of the electrical (electronic) equipment 1. The remote control 2 has a transmitting circuit 21 therein as well; thus, signals will be transmitted from the transmitting circuit 21, and the receiving circuit 11 will receive the signals when the remote control 2 is used to control the electrical (electronic) equipment 1. And, the signaling mechanism 31 is fitted on the remote control 2 and electrically connected to the receiving mechanism 3; the signaling mechanism 31 can be a buzzer or a light emitting unit including several light emitting diodes.

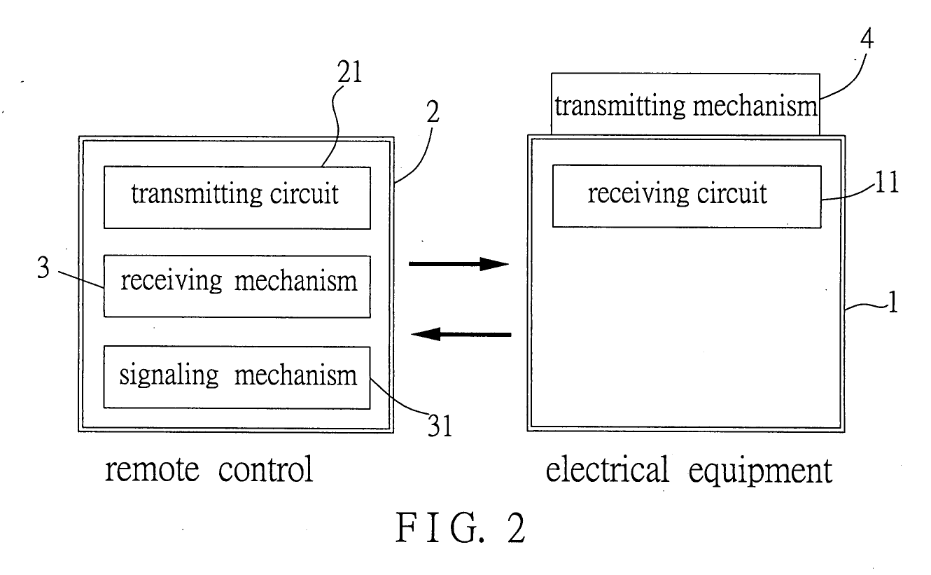

Referring to FIG. 2, which is a block diagram of a second preferred embodiment of the invention, the transmitting mechanism 4 is positioned outside the electrical (electronic) equipment 1 instead.

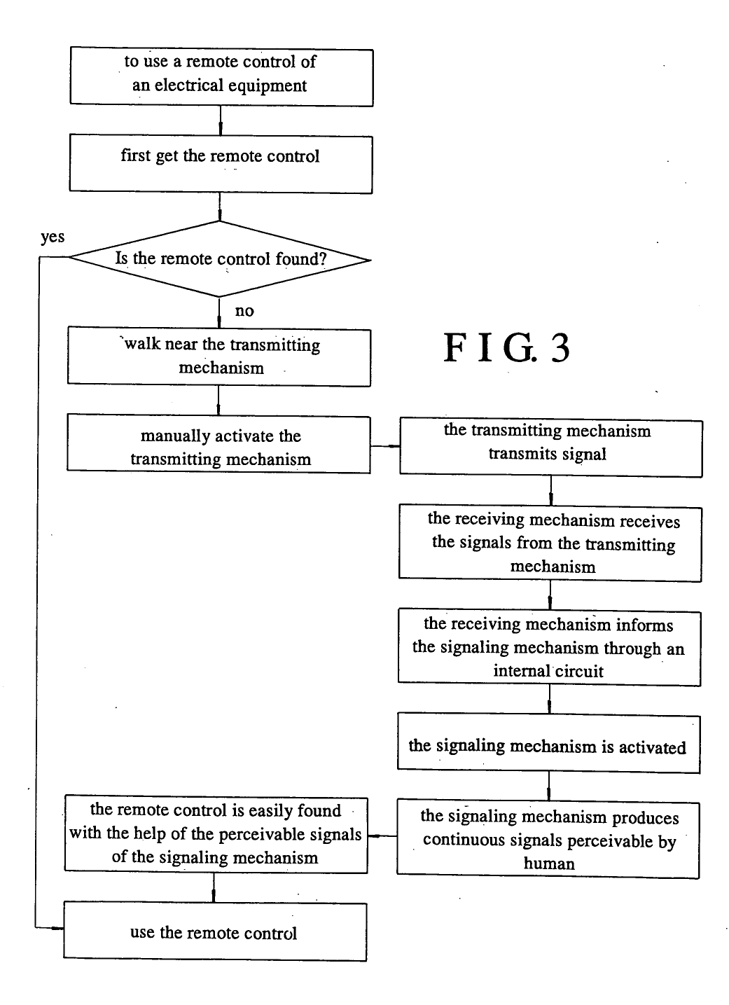

Thus, referring to FIG. 3, when one person wants to find and use the remote control 2, he/she is allowed to make the signaling mechanism 31, which is fitted on the remote control 2, produce signals such as sound and light by means of activating the transmitting mechanism 4 such that he/she can find the remote control 2 easily; when the transmitting mechanism 4 is activated, it will transmit signals, and the receiving mechanism 3 will receive the signals, and in turn the signaling mechanism 31 will produce signals; sound will be produced if the signaling mechanism 31 is a buzzer, and light will be produced if the signaling mechanism 31 is a light emitting unit.

From the above description, it can be easily understood that even when the user has forgotten the place where the remote control of the electrical (electronic) equipment was put, the remote control still can be easily found with the help of the transmitting mechanism, the receiving mechanism and the signaling mechanism of the present invention.

What is claimed is:

1. A device for helping find a remote control, comprising
a receiving mechanism positioned in a remote control of an electrical equipment;
a signaling mechanism electrically connected to the receiving mechanism; and
a transmitting mechanism; the signaling mechanism being going to produce signals as soon as the receiving mechanism receives signals transmitted from the transmitting mechanism.

2. The device for helping find a remote control as claimed in claim 1, wherein the transmitting mechanism is positioned in the electrical equipment equipped with the remote control.

3. The device for helping find a remote control as claimed in claim 1, wherein the transmitting mechanism is positioned outside the electrical equipment equipped with the remote control.

4. The device for helping find a remote control as claimed in claim 1, wherein the signaling mechanism consists of light emitting diodes.

5. The device for helping find a remote control as claimed in claim 1, wherein the signaling mechanism is a buzzer.
